(19) United States
(12) Patent Application Publication
(10) Pub. No.: US 2025/0181897 A1
(43) Pub. Date: Jun. 5, 2025

(54) STEP-UNROLLED DENOISING NEURAL NETWORKS

(71) Applicant: GDM Holding LLC, Mountain View, CA (US)

(72) Inventors: Nikolay Savinov, London (GB); Junyoung Chung, London (GB); Mikolaj Binkowski, London (GB); Aaron Gerard Antonius van den Oord, London (GB); Erich Konrad Elsen, Naperville, IL (US)

(21) Appl. No.: 19/051,041

(22) Filed: Feb. 11, 2025

Related U.S. Application Data
(63) Continuation of application No. 18/698,260, filed on Apr. 3, 2024.
(60) Provisional application No. 63/252,979, filed on Oct. 6, 2021.
(60) Provisional application No. 63/252,617, filed on Oct. 6, 2021.

(51) Int. Cl. G06N 3/0455; G06N 3/08

(52) U.S. Cl. CPC G06N 3/0455; G06N 3/08

(57) ABSTRACT

Methods, systems, and apparatus, including computer programs encoded on computer storage media, for generating output sequences using a non-auto-regressive neural network.

### CROSS-REFERENCE TO RELATED APPLICATIONS

This application is a continuation of U.S. patent application Ser. No. 18/698,260, filed Apr. 3, 2024, which is a National Stage Application under 35 U.S.C. § 371 and claims the benefit of International Application No. PCT/EP2022/077806, filed Oct. 6, 2022,which claims priority to U.S. Provisional Application No. 63/252,617, filed on Oct. 6, 2021, and U.S. Provisional Application No. 63/252,979, filed Oct. 6, 2021. The disclosure of the prior applications are considered part of and are incorporated by reference in the disclosure of this application.

### BACKGROUND

This specification relates to processing inputs using neural networks. Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that generates output sequences using a non-auto-regressive neural network.

In particular, the neural network includes a decoder neural network that is configured to receive as input a current output sequence.

The current output sequence includes a respective output token from a vocabulary of output tokens at each of a plurality of output positions.

The decoder neural network is configured to process the current output sequence while conditioned on a context input to generate a decoder output that includes, for each of the plurality of output positions, a respective score for each output token in the vocabulary of output tokens.

Thus, the system can use the neural network to iteratively generate a new output sequence by, at each iteration, replacing one or more of the tokens in the current output sequence as of the iteration with tokens selected using the scores generated by the decoder neural network.

Particular embodiments of the subject matter described in this specification can be implemented so as to realize one or more of the following advantages.

Autoregressive (AR) models have shown excellent results in generating sequences of text and other tokens. However, while their training scales very well, sampling is prohibitively slow for many practical applications. Moreover, there are limitations to the kinds of conditioning AR models can seamlessly handle: the left-to-right restriction makes it hard to “fill in the gaps” in a partially written text draft or other incomplete sequence. Finally, AR models require network architectures to be causal, severely limiting the kinds of neural network architectures that can be used for text-modeling.

This specification describes how to train a non-autoregressive neural network to accurately generate output sequences and how to use the trained neural network to decode output sequences. Unlike other non-autoregressive approaches, which trail behind the

AR benchmark and actually require distillation of a larger AR model, the described techniques are both faster than AR approaches and achieves results that match or exceed those of AR approaches on sequence generation tasks. For example, the described techniques can be used to achieve state of the art performance among non-AR models on machine translation tasks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example sequence generation system.

FIG. 2 is a flow diagram of an example process for training the neural network system.

FIG. 3 illustrates the training of the neural network system when a single update iteration is performed. FIG. 4 is a flow diagram of an example process for generating an output sequence.

FIG. 5 is a flow diagram of an example process for performing a subsequent generation iteration.

Like reference numbers and designations in the various drawings indicate like elements.

### DETAILED DESCRIPTION

This specification describes systems implemented as computer programs on one or more computers in one or more locations that generates output sequences using a non-auto-regressive neural network.

The system can be configured to generate any of a variety of types of sequential outputs, e.g., text, audio, image data, and so on.

As one example, the system can receive a context input as part of a request and generate an output sequence that is a response to the request. As a particular example, the system can be part of a dialog system and the context data can be a prompt submitted by a user of the dialog system.

As another example, if the context input is a sequence of words i.e. text in one, e.g. natural, language, the output sequence generated by the neural network may be a translation of the input text into another, e.g. natural, language, i.e. a sequence of words that is the translation.

As another example, if the context input is a sequence representing a spoken utterance (such as a digitized audio waveform e.g. using a time-frequency domain representation), the output sequence generated by the neural network may be a piece of text (i.e. a sequence of words) that is the transcript for the utterance.

As another example, the context data can be a prompt and the output sequence can be text that follows the prompt, i.e., so that the neural network performs a conditional text generation task.

As another example, the context input can be text in a natural language or features of text in a natural language and the output sequence is a spectrogram or other data defining audio of the text being spoken in the natural language (when the tokens described later may represent audio frames).

As another example, the context input can be an image, i.e., the intensity values of the image pixels or of patches of the image pixels, and the output sequence is a text sequence that represents a caption for the image.

As another example, the context input be any conditioning input for generating an image, e.g. a text input or a representation of a conditioning image, and the target or final output sequence represents pixels of an image according to the conditioning input (when the tokens described later may represent individual pixel values, or groups of pixels such as image patches). This can be used, e.g. to generate an image that is described by the text or is similar to the conditioning image, or for in-filling an image.

As another example, the context input can be computer code or a text description of the function of computer code and the output sequence can be a sequence of computer code in a programming language that completes the input code in the context input or that performs the function described in the context input.

As another example, the context input can be a sequence representing a molecule e.g. as a graph or using SMILES (Simplified Molecular Input Line Entry System), or a

DNA or RNA sequence, or a text description of one or more characteristics or properties of a molecule for synthesis; and the output sequence can be a sequence representing a molecule for synthesis e.g. having the desired characteristics or properties, or being similar to the context input. A molecule may be synthesized according to the output sequence.

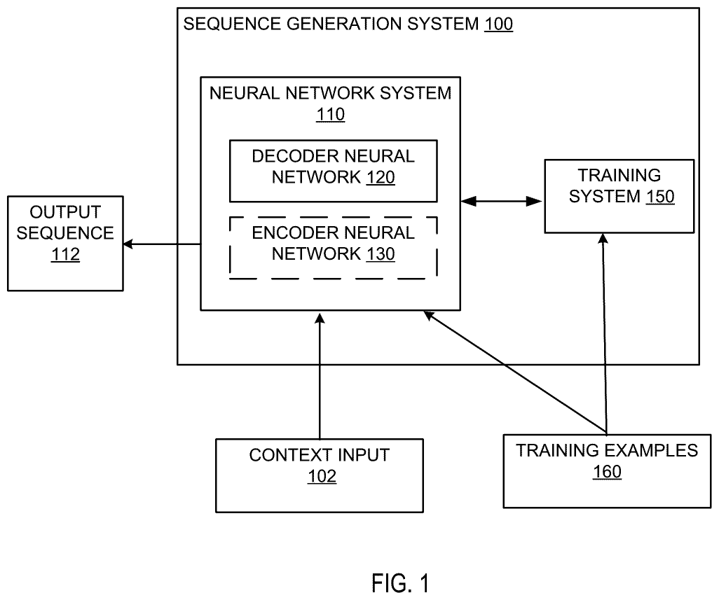

FIG. 1 shows an example sequence generation system 100. The sequence generation system 100 is an example of a system implemented as computer programs on one or more computers in one or more locations, in which the systems, components, and techniques described below can be implemented.

The sequence generation system 100 processes context inputs 102 using a neural network system 110 to generate output sequences 112.

As described above, the system can be configured to generate any appropriate type of output sequence 112 conditioned on any appropriate type of context input 102.

Generally, each output sequence 112 includes a respective output token from a vocabulary of tokens at each of multiple output positions.

For example, when the system 100 generates text sequences, the tokens in the vocabulary can be any appropriate text tokens, e.g., words, word pieces, punctuation marks, and so on, that represent elements of text in one or more natural languages and, optionally, numbers and other text symbols that are found in a corpus of text. For example, the system 100 can tokenize a given sequence of words by applying a tokenizer, e.g., the SentencePiece tokenizer (Kudo et al., arXiv: 1808.06226) or another tokenizer, to divide the sequence into tokens from the vocabulary.

To allow the system 100 to generate variable-length output sequences, the vocabulary can also include a “padding” token that indicates that there should be no token at a given output position in the final output of the system 100.

More specifically, the neural network system 110 includes a decoder neural network 120.

The decoder neural network 120 is configured to receive as input a current output sequence that includes a respective output token from the vocabulary of output tokens at each of a plurality of output positions and to process the current output sequence while conditioned on a context input to generate a decoder output that includes, for each of the plurality of output positions, a score distribution that includes a respective score, e.g. a logit value, for each output token in the vocabulary of output tokens. As used in this specification, the “score” generated by the neural network can refer to either the logit value generated by the neural network or a probability generated by applying a softmax to the set of logit values for the output tokens.

Generally, the decoder neural network 120 is a non-auto-regressive neural network that generates the entire decoder output in parallel, i.e., generates the score distributions for all of the output positions in a single forward pass. However the decoder neural network 120 can be an auto-regressive neural network, e.g. a recurrent neural network.

For example, the decoder neural network 120 can be implemented as a non-causal transformer decoder or another neural network that generates score distributions for multiple output positions in a single forward pass. A transformer network can be a neural network characterized by having a succession of self-attention neural network layers. A self-attention neural network layer has an attention layer input for each element of the input and applies an attention mechanism over the attention layer input to generate an attention layer output for each element of the input; there are many different attention mechanisms that may be used.

The system 100 can then use the decoder output to update the current output sequence.

After training, by repeatedly updating a current output sequence using the decoder neural network 120, the system 100 can generate an output sequence 112 for a given received context input 102 in a non-auto-regressive manner.

That is, the system 100 can update the current output sequence at each of multiple generation iterations while conditioned on the context input 102 and then use the current output sequence after the final generation iteration to generate the output sequence 112.

Because the number of generation iterations is generally very small, e.g., equal to 6, 8, 10, 12, or 16, relative to the number of positions in the output sequence 112, the system 100 can generate output sequences with greatly reduced latency relative to systems that use auto-regressive models.

In some cases, the context input 102 is part of the output sequence 112, i.e., the system 100 is attempting to complete an output sequence with missing tokens or to generate a continuation of an output sequence 112. The tokens in the output sequence 112 that are not part of the context input can be initialized randomly from the vocabulary of output tokens.

In some other cases, the neural network system 110 also includes an encoder neural network 130 that is configured to process the context input 102 to generate an encoded representation of the context input 102, e.g. that includes a sequence of one or more embeddings of the context input. The decoder neural network 120 is conditioned on the encoded representation, e.g., by attending over the encoded representation. In these cases, all of the tokens in the output sequence can be initialized randomly prior to the first generation iteration.

For example, when the context input 102 is text, the encoder neural network 130 can be a transformer encoder that generates a sequence of embeddings that each represent a respective text token in the context input 102.

As another example, when the context input 102 is an image, the encoder neural network 130 can be a vision transformer (e.g. Dosovitskiy et al., arXiv: 2010.11929) or a convolutional neural network that generates a sequence of embeddings that each represent a respective patch of the image.

When the neural network system 110 includes an encoder neural network 130, the decoder neural network 120 can be conditioned on the encoded representation generated by the encoder neural network 130 in any of a variety of ways. As a particular example, the decoder 120 can include one or more cross-attention layers that apply cross-attention into the encoded representation (e.g. Vaswani et al., arXiv: 1706.03762).

In some implementations, the neural network system 110 includes a length prediction neural network. A length prediction neural network is a neural network that processes the embeddings of the context input 102 to generate a length prediction that defines a predicted target length that represents a predicted number of output tokens in the final output sequence.

The system 100 then includes, as part of the encoded representation that is used to condition the decoder 120, an embedding of the predicted target length of the output sequence. Making use of the length prediction neural network in this way can help “guide” the decoder neural network 120 to determine when to predict padding tokens for the terminal positions in the output sequence without requiring the decoder neural network 120 to generate a sequence that is the length predicted by the length prediction neural network.

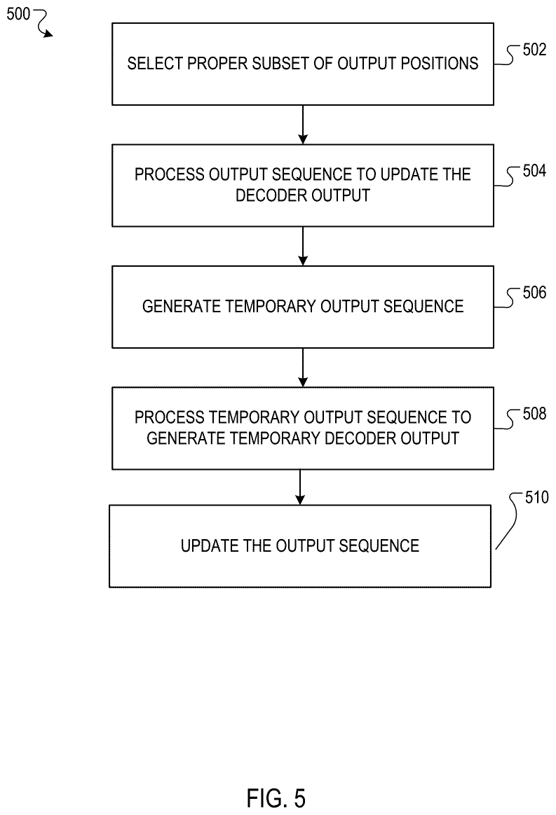

Using the neural network system 110 to generate an output sequence at inference is described below with reference to FIGS. 4 and 5.

Prior to using the neural network system 110 to generate output sequences 112, a training system 150 within the system 100 trains the neural network system 110 on training examples 160.

Generally, each training example 160 includes a training context input and a training output sequence, i.e., a ground truth training output sequence that should be generated by the neural network system 110 from the training context input.

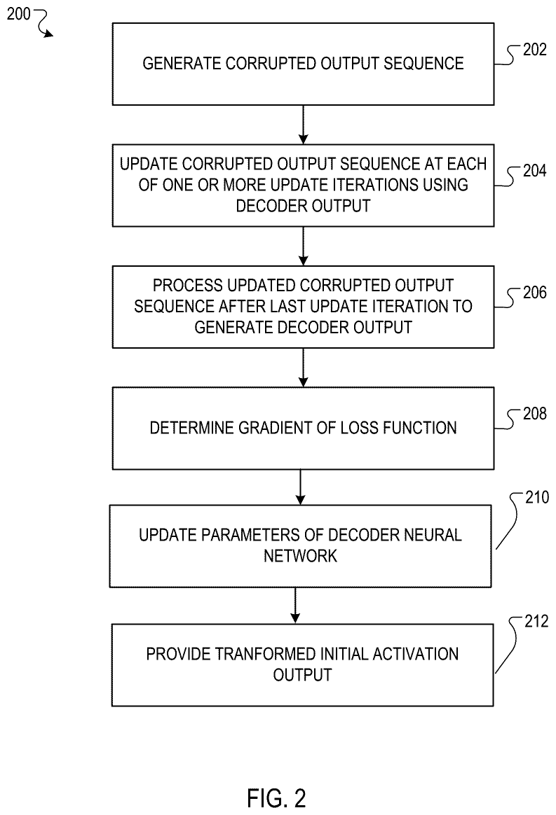

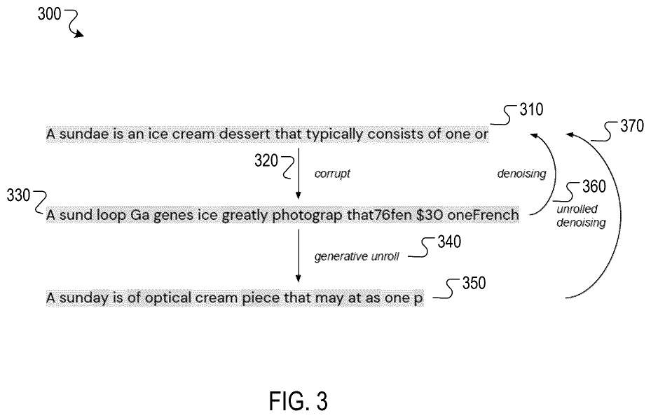

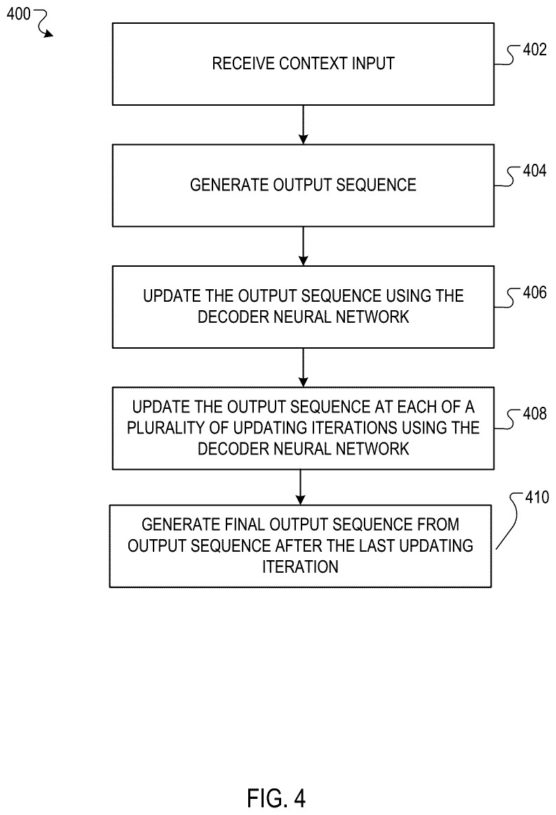

Training the neural network system 110 is described in more detail below with reference to FIGS. 2 and 3.

FIG. 2 is a flow diagram of an example process 200 for training the neural network system. For convenience, the process 200 will be described as being performed by a system of one or more computers located in one or more locations. For example, a sequence generation system, e.g., the sequence generation system 100 of FIG. 1, appropriately programmed, can perform the process 200.

The system can repeatedly perform iterations of the process 200 on different batches of training examples to update the parameters of the neural network system, i.e., of the decoder neural network and, optionally, the encoder neural network.

That is, at each iteration of the process 200, the system obtains a batch of one or more training examples, e.g., by sampling the batch from a larger set of training data, and uses the batch of one or more training examples to update the parameters of the neural network system. If a given output sequence includes less than the maximum number output tokens, the system can augment the output sequence with padding tokens prior to using the given output sequence for training.

The system can continue performing iterations of the process 200 until termination criteria for the training of the neural network system have been satisfied, e.g., until the parameters have converged, until a threshold amount of wall clock time has elapsed, or until a threshold number of iterations of the process 200 have been performed.

Each training example includes a training context input and a target output sequence for the training context input.

At each iteration of the process 200, the system performs steps 202-206 for each training example in the batch.

In particular, the system generates a corrupted output sequence from the target output sequence in the batch (step 202).

The system generates the corrupted output sequence by, for each of one or more tokens in the output sequence, replacing the output token in the output sequence with a randomly selected token from the vocabulary.

The system can determine which output tokens to replace with a randomly selected token in any of a variety of ways.

For example, the system can sample an expected corruption proportion value from a distribution over possible expected corruption proportion values. Each corruption proportion value defines the proportion of the output tokens in the output sequence that are expected to be corruption by performing the corruption process.

The system can then determine, for each output position, whether to replace the output token at the output position in the target output sequence using the expected corruption proportion, i.e., by determining to replace the output token with a probability equal to the expected corruption proportion and determining not to replace the output token with a probability equal to one minus the expected corruption proportion.

For each output position for which it is determined to replace the output token, the system can sample a random token from the vocabulary and replace the output token at the output position with the sampled random token from the vocabulary.

Thus, the resulting corrupted output sequence will generally include some randomly selected tokens and some original tokens from the output sequence in the training example.

The system then updates the corrupted output sequence at each of one or more update iterations (step 204).

The number of update iterations is generally fixed to be the same number for each training example in the batch and, in some cases, is fixed throughout training. As a particular example, the system can perform only a single update iteration for each training example throughout training. As another particular example, the system can perform two update iterations for each training example throughout training.

In particular, at each update iteration, the system processes the corrupted output sequence as of the update iteration using the decoder neural network while the decoder neural network is conditioned on the training context input in the training example to generate a decoder output for the corrupted output sequence as of the update iteration. As described above, the decoder output includes a respective score for each output token in the vocabulary. Additionally, as described above, the decoder neural network can be conditioned on the context input by either including tokens from the context input in the output sequence (and preventing the system from corrupting them) or by being conditioned on an encoded representation of the context input generated by the encoder neural network. When the length prediction neural network is used at inference, the system can also condition the decoder on the ground truth length of the training output sequence (prior to the addition of the padding tokens).

The system then updates the corrupted output sequence by, for each of the plurality of output positions, selecting a token from the vocabulary of output tokens using the decoder output for the corrupted output sequence. For example, the system can sample a token in accordance with the scores or can select the highest-scoring output token.

Thus, each update iteration replaces the tokens in output sequence as of the beginning of the iteration with tokens that have been selected using the output of the decoder neural network.

After the last update iteration has been performed, the system processes the updated corrupted output sequence after the last update iteration using the decoder neural network while the decoder neural network is conditioned on the training context input to generate a decoder output for the updated corrupted output sequence (step 206). This decoder output also includes a respective score for each output token in the vocabulary.
The system then determines a gradient with respect to the parameters of the decoder neural network of a loss function (step 208).

The loss function includes a first term that measures, for each training example, the quality of the decoder output for the updated corrupted output sequence after the last update iteration relative to the target output sequence. The first term of the loss function term, that measures the quality of the decoder output, may represent a first term in a reconstruction loss for the target output sequence.

For example, the first term can be a negative log likelihood term that measures, for each training example and for each output position, a logarithm of the score assigned by the decoder output for the updated corrupted output sequence to the output token at the output position in the target output sequence. For example, the first term can be the negative of the average of, for each training example, the sum of, for each output position, the logarithm of the score assigned by the decoder output for the updated corrupted output sequence to the output token at the output position in the target output sequence.
Optionally, the loss function can also include a respective second term for each update iteration. The second term for a given update iteration measures, for each training example, the quality of the decoder output for the corrupted output sequence as of the update iteration (that is, instead of the updated corrupted output sequence after the last update iteration) relative to the target output sequence. The second term of the loss function term, that measures the quality of the decoder output, may represent a second term in the reconstruction loss for the target output sequence.

For example, each second term can be a negative log likelihood term that measures, for each training example and for each output position, a logarithm of the score assigned by the decoder output for the corrupted output sequence as of the update iteration to the output token at the output position in the target output sequence. For example, the second term can be the negative of the average of, for each training example, the sum of, for each output position, the logarithm of the score assigned by the decoder output for the corrupted output sequence as of the update iteration to the output token at the output position in the target output sequence.

Generally, the system does not backpropagate through the sampling operation, i.e., the step of selecting tokens using the decoder output at the update iterations, when computing gradients of the first term and, when included, the second term(s). That is, the system applies a “stop gradient” after each update iteration when computing each of the gradient terms.

When the loss function has multiple terms, the overall loss function can be a sum or a weighted sum of the individual terms.

The system updates the parameters of the decoder neural network using the gradient (step 210). For example, the system can apply an appropriate optimizer, e.g., the Adam optimizer, the rmsProp optimizer, the Adafactor optimizer, or a different machine learning optimizer, to the gradient and to the parameters to update the parameters.

When the neural network system also includes an encoder neural network, the system can also compute gradients with respect to the loss function with respect to the encoder parameters, i.e., by backpropagating the gradients through the decoder neural network into the encoder neural network, and then update the parameters of the encoder neural network using the gradient, e.g., using an optimizer as described above.

When the neural network system also includes a length prediction neural network this can be trained separately (but on the same training examples) using supervised training, e.g. based on a cross-entropy loss.

Thus, by repeatedly performing the process 200, the system can efficiently train the neural network to generate accurate output sequences. In particular, the system can use a smaller number of update iterations than will be later used at inference, increasing the computational efficiency of the training. To compensate for that, i.e., to ensure that the neural network is still trained to maximize inference accuracy, the system starts from corrupted output sequences, rather than from output sequences sampled from a prior distribution or a noise distribution as is done at inference. This way, the model learns to denoise the samples it is likely to encounter during the full unroll used at inference time.

This efficient training is illustrated in FIG. 3.

FIG. 3 shows an example of the training process for a training example when a single update iteration is performed. In the example of FIG. 3, the tokens are word pieces, e.g., generated by tokenizing the training data using a word piece model, e.g., the SentencePiece model or another appropriate word piece tokenizer.

As shown in FIG. 3, the training example includes a training output sequence 310 that reads “A sundae is an ice cream dessert that typically consists of one or.”

The system then performs corruption 320 to generate a corrupted training sequence 330 that replaces multiple ones of the word pieces with randomly selected word pieces to yield “A sund loop Ga genes ice greatly photograp that 76fen $30 oneFrench.”

The system then performs a “generative unroll” 340, i.e., performs a single update iteration as described above, to generate the updated corrupted sequence 350 “A sunday is of optical cream piece that may at as one p.” As can be seen from the example, the neural network is not able to correctly reconstruct the output sequence 310 in a single update iteration, but the updated corrupted sequence 350 is much closer to the output sequence 310 than the corrupted output sequence 330.

The system then computes a loss that includes a denoising term 360 (the “first term” described above) that measures the decoder output generated from the corrupted output sequence 330 relative to the training output sequence 310 and an unrolled denoising term 370 (the “second term” for the single update iteration described above) that measures the decoder output generated from the updated corrupted output sequence 350 relative to the training output sequence 310.

Thus, even though only a single update iteration is performed, the loss still measures the performance of the neural network in predicting from both a sequence that is significantly different from the target output, i.e., a sequence that is likely to be seen at early update iterations at inference, and a sequence that is somewhat similar to the target output, i.e., a sequence that is likely to be seen at later update iterations at inference.

FIG. 4 is a flow diagram of an example process 400 for generating a final output sequence from a context input. For convenience, the process 400 will be described as being performed by a system of one or more computers located in one or more locations. For example, a neural network system, e.g., the sequence generation system 100 of FIG. 1, appropriately programmed, can perform the process 400.

The system receives a (new) context input (step 402).

The system generates a (new) output sequence that includes a respective output token at each of the plurality of output positions (step 404).

For example, the system can sample each token randomly from the vocabulary or can sample each token randomly from a prior distribution over the tokens in the vocabulary.

As another example, when the task is to complete a partial output sequence, i.e., a sequence that includes some of the tokens in the output sequence but that has a missing tokens at one or more positions, and the context input includes the partial output sequence, the system can generate the new output sequence based on the context input, i.e., by generating an output sequence that has the tokens from the context input at the appropriate positions and that replaces the missing tokens with tokens sampled randomly or from the prior distribution.

For example, the context input can include one or more initial tokens in the output sequence when the task requires completing an input sequence or can include one or more tokens at positions throughout the output sequence when the task requires “in-filling” a partial input sequence.

When the neural network system includes an encoder neural network, the system also processes the context input using the encoder neural network to generate an encoded representation of the context input that includes a sequence of one or more embeddings of the context input.

When the neural network system also includes a length prediction neural network, the system processes the one or more embeddings of the context input using the length prediction neural network to generate a length prediction that defines a predicted target length that represents a predicted number of output tokens in the final output sequence. The system then includes the predicted target length as part of the encoded representation, e.g., by concatenating an embedding of the predicted target length onto the sequence of one or more embeddings generated by the encoder.

The system then updates the new output sequence at each of a plurality of generation iterations (step 406).

In particular, the system generally performs a fixed number of generation iterations, e.g., 4, 8, 12, or 16 update iterations. As described above, the number of generation iterations is generally larger than the number of update iterations that were used during the training.

At each update iteration, the system uses the decoder neural network to update the new output sequence while the decoder neural network is conditioned on the new context input.

In particular, at each generation iteration, the system processes the new output sequence as of the generation iteration using the decoder neural network while the decoder neural network is conditioned on the new context input to generate a decoder output for the new output sequence.

When the neural network system includes an encoder neural network, the decoder neural network is conditioned on the encoded representation (that optionally also includes an embedding of the output of the length prediction neural network).
The system then selects, for a subset of the plurality of output positions, a token from the vocabulary of output tokens using the decoder output for the new output sequence. The subset may, but need not be, a proper subset, where a proper subset of the output positions is one that that does not include all the output positions. Mathematically, and as used herein, a subset can include all the output positions in the plurality of output positions (i.e. it includes the “improper subset”). Put differently, the system then selects, for either a proper subset of the plurality of output positions or for all the plurality of output positions, a token from the vocabulary of output tokens using the decoder output for the new output sequence.

In some implementations, the system selects a token for all of the output positions, i.e., the subset is not a proper subset.

In some other implementations, the system selects a token for only a proper subset of the output positions. For example, the system can randomly select the proper subset of output positions, and then only select new tokens for the positions in the proper subset. Updating only a proper subset of the output positions can assist the system in generating diverse final output sequences for tasks where diversity is required, e.g., conditional or unconditional text generation.

In some implementations, to select a token for a given output position, the system can sample a token using the decoder output. As a particular example, the system can apply a temperature value to each respective score in the decoder output to generate temperature-adjusted scores and sample the tokens using the temperature-adjusted scores. Applying a temperature value t to a score, score, may comprise determining a modified score, score^{τ}, such that

$$log ( {score}^{τ} ) ∝ \frac{1}{τ} log ( score ) .$$

That is, the system can, for each output position, process the scores (“logits”) for the tokens using a softmax with reduced temperature, i.e., a temperature between zero and one, to generate a distribution over temperature-adjusted scores (probabilities) and then sample the tokens using the temperature-adjusted scores. Reducing the temperature can assist the system in converging to high quality output sequences in fewer generation iterations.

In other implementations, the system uses argmax-unrolled decoding to select the tokens at each generation iteration.

When performing argmax-unrolled decoding, at the first generation iteration, the system selects a respective token for each output position, e.g., by sampling from the score distribution, with or without a reduced temperature.

The system then passes, to each subsequent generation iteration, the decoder output from the preceding iteration in addition to the updated output sequence and, at the subsequent iteration, uses the decoder output from the preceding iteration to update the output sequence. Updating the output sequence at a subsequent generation iteration when the system uses argmax-unrolled decoding is described in more detail below with reference to FIG. 5.

The system generates a final output sequence for the new context input from the new output sequence after the last generation iteration of the plurality of updating iterations (step 408).

In some implementations, the system directly uses the new output sequence to generate the final output sequence, e.g., by removing any padding tokens from the new output sequence and providing the resulting sequence as the final output sequence.

In some other implementations, the system performs multiple iterations of the process 400 in parallel to generate multiple new output sequences and then only directly uses the new output sequence that has the highest score, e.g., the highest log likelihood, to generate the final output sequence.

FIG. 5 is a flow diagram of an example process 500 for updating the output sequence at a subsequent generation iteration when the system uses argmax-unrolled decoding. For convenience, the process 500 will be described as being performed by a system of one or more computers located in one or more locations. For example, a neural network system, e.g., the sequence generation system 100 of FIG. 1, appropriately programmed, can perform the process 500.

As described above, at the first generation iteration, the system processes the output sequence using the decoder neural network that is conditioned on the context input to generate a decoder output and updates the output sequence by selecting, for each output position, a respective token from the vocabulary of tokens using the decoder output.

The system then performs the process 500 at each subsequent generation iteration. The system selects, using the decoder output as of the updating iteration, a proper subset of the output positions (step 502). In particular, the system can select the proper subset by selecting a threshold number of most-uncertain output positions. For example, the system can select a threshold number of output positions for which the output token at the output position received the lowest score in the decoder output.

The system processes the output sequence as of the generation iteration using the decoder neural network that is conditioned on the context input to update the decoder output (step 504).

After updating the decoder output, the system generates a temporary output sequence by, for each of the output positions in the proper subset, sampling a token using the decoder output (step 506).

For each of the output positions not in the proper subset, the system selects a token using the decoder output or using, as the token at the output position, the token in the output position as of the updating iteration.

The system processes the temporary output sequence using the decoder neural network that is conditioned on the context input to generate a temporary decoder output (step 508).

The system then updates the output sequence (step 510).

In particular, the system updates the output sequence by, for each output position not in the proper subset, selecting a token from the vocabulary using the decoder output. More specifically, the system selects the argmax token (i.e. a token with a highest score) for the position according to the decoder output.

For each output position in the proper subset, the system selects a token from the vocabulary using the temporary decoder output. More specifically, the system selects the argmax token for the position according to the temporary decoder output. Thus, tokens in the most-uncertain proper subset are selected using an additional “unroll” step relative to tokens not in the proper subset. That is, subsequent generation iterations are performed by resampling the low-certainty tokens in accordance with unrolled logits rather than just single-step predicted logits. This can result in improvements in sampling speed, i.e., by requiring fewer generation iterations to be performed, while maintaining output sequence quality.

TABLE 1

| | | Raw BLEU | |
|---|---|---|---|
| Model | [symbol] | EN→DE | DE→EN |
| AR Models | | | |
| [symbol] | — | [symbol] | [symbol] |
| Non-AR Models | | | |
| [symbol] | [symbol] | — | — |
| [symbol] | — | — | — |
| [symbol] | [symbol] | — | — |
| [symbol] | [symbol] | [symbol] | — |
| [symbol] | [symbol] | — | — |
| [symbol] | [symbol] | [symbol] | [symbol] |
| [symbol] | [symbol] | — | — |
| [symbol] | [symbol] | — | — |
| [symbol] | [symbol] | [symbol] | — |
| [symbol] | [symbol] | [symbol] | — |
| [symbol] | [symbol] | — | — |
| [symbol] | [symbol] | — | — |
| [symbol] | [symbol] | [symbol] | — |
| [symbol] | [symbol] | — | — |
| [symbol] | [symbol] | — | — |
| [symbol] | [symbol] | — | — |
| [symbol] | [symbol] | — | — |
| [symbol] | [symbol] | — | — |
| [symbol] | [symbol] | [symbol] | — |
| [symbol] | [symbol] | [symbol] | — |
| [symbol] | | | |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |
| [symbol] | [symbol] | [symbol] | [symbol] |

[symbol]

indicates data missing or illegible when filed

Table 1 shows the performance of various systems on two machine translation tasks, English to German (EN→DE) and German to English (DE→EN). In particular, the table shows the performance of each system, on each task in terms of Raw BLEU score. The other systems include both auto-regressive (AR) systems and other non-AR systems. The table shows the performance of the described techniques (SUNDAE) with both argmax-unrolled decoding (“deterministic”) and without (“stochastic”) and for a variety of generation steps T.

As can be seen from Table 1, the described techniques are competitive with the AR system despite decreased latency and achieve better performance than other non-AR systems. Moreover, as can be seen from Table 1, the deterministic variants achieve superior performance to the stochastic variants for smaller numbers of generation steps.

TABLE 2

| | Relative |
|---|---|
| | Speed |
| Steps (T) | Improvement |
| 4 | 4.7x |
| 8 | 2.6x |
| 10 | 2.2x |
| 16 | 1.4x |

Table 2 shows the improvements achieved by the described techniques on the EN→DE translation task relative to an AR model (the Transformer base model described above) with various numbers of generation steps T. As can be seen from the Table, the described techniques achieve significant speed-ups relative to the AR model even with 16 generation steps and, for smaller numbers of generation steps, can achieve up to 4.76×speed improvement while still achieving reasonable quality.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework. Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous. CLAIMS

1. A method performed by one or more computers, the method comprising:
generating an output sequence that comprises a token at each of a plurality of output positions, wherein each token is selected from a vocabulary of tokens; and
generating a final output sequence based on updating the output sequence across a plurality of generation iterations, the generating comprising, at each of one or more generation iterations:
obtaining a current output sequence as of the generation iteration;
processing a decoder input that comprises the current output sequence as of the generation iteration using a decoder neural network to generate a decoder output that includes, for each of the plurality of output positions, a respective score for each token in the vocabulary of tokens; and
updating the current output sequence using the denoising output to generate an updated output sequence, wherein the updating comprises replacing one or more of the tokens in the current output sequence as of the iteration with tokens selected from the vocabulary of tokens using the scores included in the decoder output generated by the decoder neural network.

2. The method of claim 1, wherein a number of the one or more generation iterations is smaller than a number of the plurality of output positions in the output sequence.

3. The method of claim 1, wherein generating the output sequence comprises randomly sampling a token from the vocabulary of tokens for each of one or more of the plurality of output positions.

4. The method of claim 1, wherein the vocabulary comprises a padding token.

5. The method of claim 4, wherein generating the final output sequence comprises:
removing any padding tokens from the updated output sequence that is generated in a last generation iteration.

6. The method of claim 1, wherein the decoder neural network is a non-auto-regressive model that generates the respective scores for each of the plurality of output positions in parallel.

7. The method of claim 1, further comprising:
receiving a context input; and
processing the context input using an encoder neural network to generate an encoded representation of the context input.

8. The method of claim 7, wherein the decoder input also comprises the encoded representation of the context input.

9. The method of claim 7, wherein the decoder neural network comprises one or more attention layers that apply an attention mechanism over the encoded representation of the context input.

10. The method of claim 9, wherein the one or more attention layers comprise one or more self-attention layers.

11. The method of claim 9, wherein the one or more attention layers comprise one or more cross-attention layers.

12. A method performed by one or more computers, the method comprising:
obtaining a target output sequence comprising a respective target token from a vocabulary of tokens at each of a plurality of output positions;
generating a corrupted output sequence from the target output sequence by, for each of one or more target tokens in the target output sequence, replacing the target token in the target output sequence with a different token selected from the vocabulary;
processing a decoder input that comprises the corrupted output sequence using the decoder neural network to generate a decoder output that comprises, for each of the plurality of output positions, a respective score for each token in the vocabulary of tokens; and
determining a gradient with respect to the parameters of the decoder neural network of a loss function that includes a term that measures a quality of the decoder output relative to the target output sequence; and
updating parameters of the decoder neural network using the gradient.

13. The method of claim 12, wherein the loss function comprises a cross-entropy loss function.

14. The method of claim 12, wherein generating the corrupted output sequence from the target output sequence comprises:
determining, for each output position, whether to replace the respective target token at the output position in the target output sequence based on a sampled value.

15. The method of claim 14, wherein generating the corrupted output sequence from the target output sequence comprises wherein generating the corrupted output sequence from the target output sequence comprises:
sampling an expected corruption proportion value from a first distribution;
determining, for each output position, whether to replace the respective target token at the output position in the target output sequence using the expected corruption proportion; and
for each output position for which it is determined to replace the respective target token:
selecting a token from the vocabulary; and
replacing the respective target token at the output position with the selected token from the vocabulary.

16. The method of claim 15, wherein determining, for each output position, whether to replace the respective target token at the output position using the expected corruption proportion comprises:
sampling a variable for the output position from a Bernoulli distribution parameterized by the expected corruption value.

17. The method of claim 12, wherein the decoder input comprises an encoded representation of a context input that is generated by an encoder neural network from processing the context input.

18. The method of claim 17, further comprising:
determining a gradient with respect to parameters of the encoder neural network of the loss function; and
updating parameters of the encoder neural network using the gradient.

19. A system comprising one or more computers and one or more storage devices storing instructions that when executed by the one or more computers cause the one more computers to perform operations comprising:
generating an output sequence that comprises a token at each of a plurality of output positions, wherein each token is selected from a vocabulary of tokens; and
generating a final output sequence based on updating the output sequence across a plurality of generation iterations, the generating comprising, at each of one or more generation iterations:
obtaining a current output sequence as of the generation iteration;
processing a decoder input that comprises the current output sequence as of the generation iteration using a decoder neural network to generate a decoder output that includes, for each of the plurality of output positions, a respective score for each token in the vocabulary of tokens; and
updating the current output sequence using the denoising output to generate an updated output sequence, wherein the updating comprises replacing one or more of the tokens in the current output sequence as of the iteration with tokens selected from the vocabulary of tokens using the scores included in the decoder output generated by the decoder neural network.

20. The system of claim 19, wherein the operations further comprise receiving a context input and processing the context input using an encoder neural network to generate an encoded representation of the context input, and wherein the decoder input also comprises the encoded representation of the context input.
